(19) United States
(12) Patent Application Publication
(10) Pub. No.: US 2005/0015287 A1
(43) Pub. Date: Jan. 20, 2005

(54) Means for incorporating sustainability metrics and total cost and benefit analysis in decision-making

(76) Inventor: Earl R. Beaver, Chesterfield, MO (US)

Correspondence Address: Todd S. Parkhurst;30th Floor, Holland & Knight LLP, 131 South Dearborn St., Chicago, IL, 60603-5144, US

(21) Appl. No.: 10/852,379

(22) Filed: May 24, 2004

Related U.S. Application Data
(60) Provisional application No. 60/472,641, filed on May 22, 2003.
(60) Provisional application No. 60/485,940, filed on Jul. 9, 2003.

(51) Int. Cl. G06F 17/60

(52) U.S. Cl. 705/7

(57) ABSTRACT

Methods are disclosed for the simplification and integration of data from a diverse set of sources for environmental costs and societal benefit data. The methods allow for the computation of five basic metrics: material use, water use, energy use, toxics emitted, land use and overall pollutants emitted. Further, they facilitate the computation of complementary metrics, as well as the estimation of net present value of costs of unrealized environmental impacts.

### CROSS REFERENCE TO RELATED APPLICATIONS

This application claims the benefit of U.S. Provisional Application No. 60/472,641, filed May 22, 2003; and U.S. Provisional Application No. 60/485,940, filed Jul. 9, 2003. Application Ser. No. 60/472,641 and Application Ser. No. 60/485,940 are hereby incorporated herein by reference.

This invention relates to computer integrated management systems, methods, computer program products, and more particularly to systems, methods and models for management decision making in industry, government and education.

### BACKGROUND OF THE INVENTION

Improvement of industrial processes in light of sustainable development is very challenging and requires a balance of safety, reliability, economics, quality, and an acceptable impact on the environment and society. Techniques such as total cost and benefit assessment, limited life cycle inventory and analysis, as well as eco-efficiency and sustainability metrics are creating a new view of plant design and product development. For industry, application of these techniques to each stage of development will play a key role in defining the best plants, products and operations, and optimization will incorporate economic (costs, yield, long-term cost of ownership) and environmental (life cycle, sustainability, contingent cost analysis) effects, quantitatively. It also makes possible the application of the techniques to complexes of facilities operated by a multiplicity of enterprises.

From a government planning perspective, there is a lack of accepted methods to assess the current total cost impact to society of changes an agency may make in its boundaries. For example, there is no standard method to balance benefit and costs. If planners are to make rational decisions from a sustainability perspective, metrics and a reasonable assessment of societal costs and benefits must be established before new facilities are built or the population changes significantly. Indicators of progress need to take into consideration material and energy use, resources depleted and the amount of pollutants dispersed over their lifecycles. They need to be assessed in the context of the total costs they represent to society as well as in the context of an overall value-added product any action generates.

The design and testing of preliminary metrics by companies under the auspices of various groups, e.g., the National Roundtable on the Environment and the Economy (Ottawa) and of total cost assessment and metrics by groups in the American Institute of Chemical Engineers (NY) have been completed. Those efforts yielded a good basis for establishing workable tools for decision making in companies; however, these tools require refinement to ensure that they are simple, easily understood, reproducible, and cost-effective in terms of data collection and suitable even for industrial decision making. In addition, work has been needed to adapt them to sectors of the economy, other than industry, and to make them stackable along the supply chain.

### BRIEF DESCRIPTIONS OF THE INVENTION

Industry, in particular the chemical industry, has developed and tested a variety of decision tools, e.g., metrics. The extension of the tools to other industries and eventually to academia and government is highly dependent upon simplifying the understanding, standardization and application of the tools. Automation is a means of accomplishing the bulk of the tasks required to do this. Government often acts to advance projects or proposals toward a single purpose, e.g., job creation. In so doing, they may provide tax abatement without evaluating the cost of increased services, e.g., sewer, police and fire protection. The consequence is jobs in the short term, but a need for increased taxes to cover the increased services reduces the attractiveness of the jurisdiction for future development. Some businesses may exit the jurisdiction to find lower tax rates. In the long term, jobs disappear from the jurisdiction and residents also leave. Automating decision tools such as metrics and cost/benefit analysis will reduce the odds and severity of such occurrences.

A novel method comprised of a combination of software and business management methods is disclosed. This combination simplifies the integration of data from a diverse set of sources for environmental costs (including social costs) and societal benefit data. The software uses an input spreadsheet to enter the manufacturing, marketing, customer use conditions and/or situations for products or services to be evaluated. Further, the output of the calculations directly and easily integrates with the business practices of an industrial enterprise and the decision planning of government entities. The method allows the computation of five basic metrics: material use, water use, energy use, toxics emitted, land use and overall pollutants emitted. Further, it allows and facilitates the computation of complementary metrics, examples of which are greenhouse gases, eutrophication materials, acidification materials, ozone creating or depleting materials. It also facilitates the estimation of the net present value of costs of unrealized environmental impacts, including but not limited to, toxicity to plants and animals, depletion of natural resources and benefits to society of use of resources, such as land and raw materials.

Metrics have been developed and are described herein. Benchmarks have been generated for more than 5000 facilities in more than 100 SIC (Standard Industrial Classification) classes of operation.

### DESCRIPTION OF THE DRAWINGS

FIG. 1. Total Cost Assessment

FIG. 2. Evolution of Costs (for example, Eutrophication and Odors)

FIG. 3. The Boundaries for Metrics Calculations.

FIG. 4. Acetic Acid Metrics Calculations (Raw Materials).

FIG. 5. Acetic Acid Metrics Calculations (Raw Materials, Energy, and Water).

### DETAILED DESCRIPTION OF THE INVENTION

Simplifying data from a diverse sets of environmental costs and societal benefits is the result of the disclosed methods. The basis for rational decisions, made from a sustainability perspective, rely upon the development of metrics and indicators of progress. These metrics and indicators consider material and energy use, resources depleted and the amount of pollutants dispersed. These need to be assessed in the context of the total mass of final product produced, total costs that they represent to society as well as in the context of an overall societal value added benefit, that any operation generates.

A preferred embodiment of this invention is a method of determining the raw material and land use inputs for a product to be manufactured or a service to be rendered, and determining the non-product outputs of producing the product or delivering the service, comprising the steps:
a. obtaining an inventory of materials and land necessary for production of the product or delivery of that service; and
b. quantifying the non-product outputs of the production or delivery, wherein the raw material inputs and non-product outputs are numerical values that are converted into common units.

Another preferred embodiment is directed to a method of determining an estimate of the benefits and costs for a product to be manufactured or a service to be rendered, and determining an estimate of the non-product outputs of producing the product or delivering the service, comprising the steps:
a. obtaining an inventory of materials and land necessary for production of the product or delivery of that service; and
b. estimating the non-product outputs of the production or delivery, wherein the raw material inputs and non-product outputs are estimated numerical values that are converted into common units.

In yet another preferred embodiment, a method for identifying, assessing, and optimizing future impacts of research and development decisions on a technology comprises the steps:
a. obtaining an inventory of materials and land necessary for production of the product or delivery of that service; and
b. quantifying the non-product outputs of the production or delivery, wherein the raw material inputs and non-product outputs are numerical values that are converted into common units.

Representation of the sustainability of a process, a facility, a project alternative, a business or a company which is understandable to the non-expert, may be provided in a method comprising
a) selecting metrics to be measured;
b) calculating the selected metrics. Assessing and reporting the these calculated metrics relative to external benchmarks, allow goals to be set and progress measured.

Government databases may be used to calculate benchmark metrics for uses selected from the group consisting of material use, energy use, water use, land use, toxic materials emitted and overall pollutants emitted, for a product manufactured or a service rendered. The method comprises the steps of:
a. extracting data from the databases.
b. calculating benchmark metrics from the data.

Non-Traditional Costs

Manufacturers typically seek net-present values for future costs to guide their current decision-making. Investors and their advisors seek cost information from industry because of concern regarding how an enterprise's overall environmental performance affects its current and future financial health and how certain practices, which have no monetized cost today, will have financial impact at some point in the future. Creditors have similar needs with the added possibility of having to assume the responsibility for rectifying environmental damage if a debtor defaults on a loan. The amount involved may be significantly greater than that of the original loan. Owners and shareholders are particularly interested because of the potential impact environmental costs may have on the financial return on their investment in the enterprise. Other interested parties could include customers, suppliers, regulators, the general public, and those acting on their behalf. However, many times, the information about current societal costs is vague. The linkage of current societal costs to current company costs has been largely undemonstrated. Most importantly, the linkage of current and future societal costs to company costs is virtually unstudied. Those shortcomings are addressed by using surrogate values for societal costs of human actions such as odors, greenhouse gas emissions, climate change, and eutrophication for which data can be obtained.

Decisions to reduce a company's impact on the environment are often times not obvious or straightforward. Also, companies with sites located in several nations must deal with international regulatory issues for their operations and trade agreements for the import/export of their products. They must also deal with differing perceptions by the societies in which they conduct their business of the costs and benefits of their operations. Pressures for external reporting of pollutant discharges and resource consumption create potential liabilities and public image issues with consumers. As laws change and societal concerns change, practices that are legally acceptable today may be illegal or unacceptable tomorrow. Advances in technology also identify new potential causes for many human conditions or disorders. Analytical techniques are making huge advances in ability to analyze progressively lower concentrations of chemical species. The use of computers and the internet provide a means for many people to rapidly communicate information. The combination of these changes accelerates the transfer of information and increases the speed at which a previously unrecognized situation becomes a national or global concern.

Comparing estimated non-traditional costs with a service to be provided is accomplished by a method comprising
a. monetizing the non-traditional costs, and
b. comparing the monetized value with the service to be provided
   Assessment of Total Costs

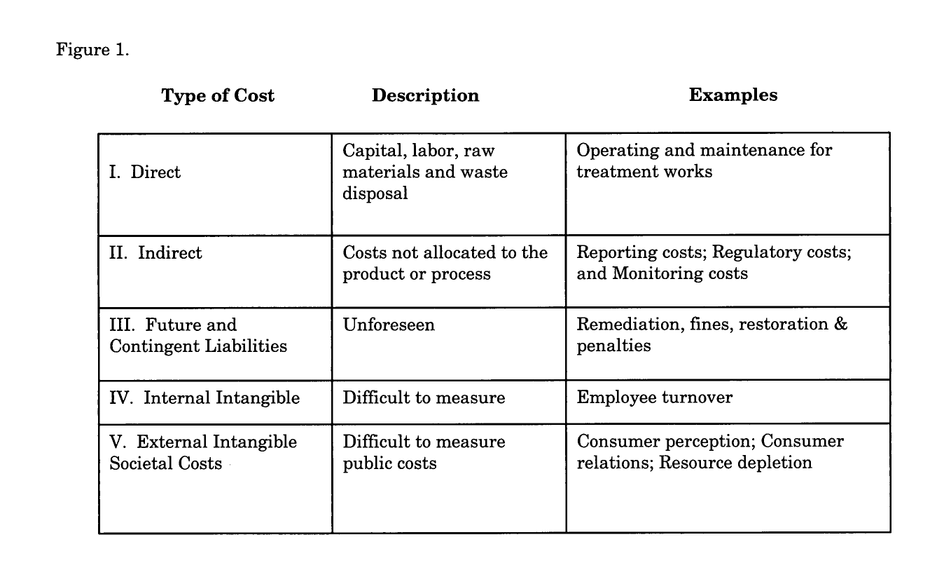

FIG. 1 represents all of the types of costs considered in Total Cost Assessment. It divides costs into five types (I-V).

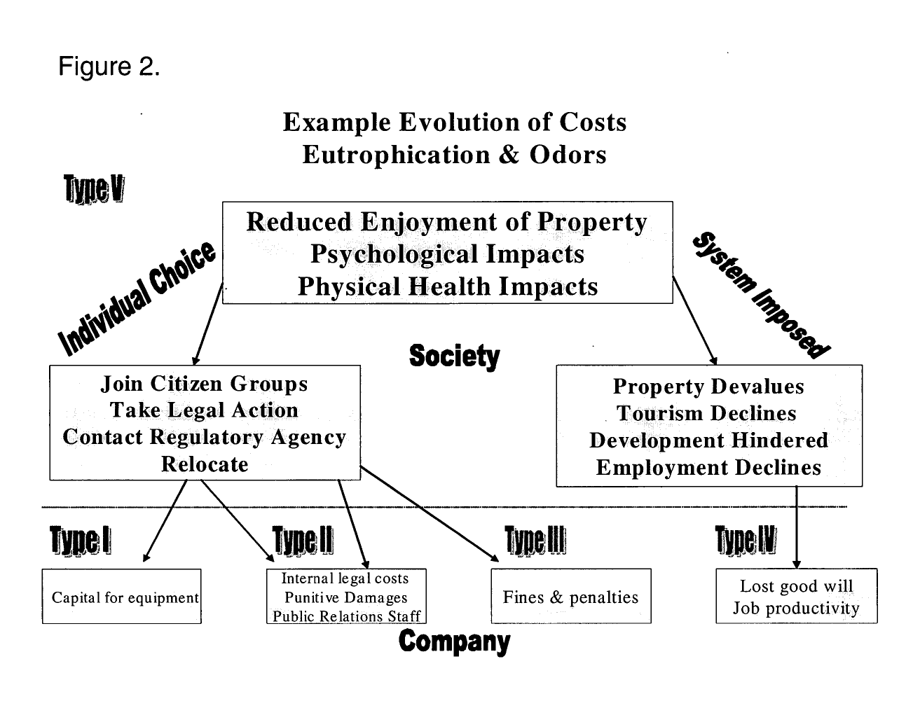

The study of the intangible costs of harmless odors and eutrophication provides an excellent example of how past, seemingly harmless, occurrences can become substantial company costs. FIG. 2 provides a depiction of the progression of costs from Type V External Intangible costs to other types of costs, which are ultimately borne by the company. An “evolution of benefits” may similarly be diagrammed, wherein Type V benefits (for example, increased enjoyment of property, psychological impacts, physical health impacts) are followed through to capital for equipment (type I), faster approvals (type II), new options (type III), and job productivity (type IV).

Assessment of Benefits

Without benefits assessment and metrics, only negative impacts would be visible. Therefore, no planned alternative would appear positive. Examples of monetizable benefits to be included in the tools are: quality of life years (extending life desirable to a person), jobs, jurisdictional increases in revenues in excess of costs, and preservation of species.

Surrogate Numbers

Information is often needed regarding costs for a particular potential future cost, but none is available. Surrogate costs can be used where a zero or no entry would be erroneous. An example is “estimated societal costs for nitrous oxide emissions.” Extensive work has been done on climate change as a result of carbon dioxide emissions, but little has been done directly on nitrous oxide emissions. A carbon dioxide equivalence factor allows one to use a simple multiplier of carbon dioxide impact costs to calculate a surrogate cost number for nitrous oxide emissions.

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art, in light of the present disclosure, can appreciate that many changes can be made in the specific embodiments which are disclosed and still obtain a like or similar result without departing from the spirit and scope of the invention.

### EXAMPLE 1

### Calculating Sustainability Metrics for an Acetic Acid Process

Methanol is reacted with carbon monoxide in the presence of a homogenous rhodium catalyst and a methyl iodide promoter at temperatures in excess of 350° F. and pressures greater than 450 psig (pounds per square inch-gauge). The reaction takes place in the liquid phase. The methanol is almost completely converted (approximately 99% selectivity to acetic acid). The reactor effluent is flashed to separate the reaction products from the unvaporized rhodium catalyst. A small portion of the catalyst stream is sent to the catalyst preparation section of the plant for regeneration; the remainder is recycled to the reactor. The crude product vapor stream from the flash is distilled in a series of columns to recover purified acetic acid. Overall yield of acetic acid from methanol is 98%; and from carbon monoxide is 91%.

In 1992, this basic process accounted for greater than 50% of the world's acetic acid capacity. The use of corrosive iodide solutions requires Hastelloy and zirconium metallurgy. The carbonylation reactor operates at about 400 psig and 350° F. Conversion of methanol is nearly 100% with 98 to 99% selectivity to acetic acid. Propionic acid is the major liquid by-product; trace quantities of higher carboxylic acids are also formed. In a water gas shift reaction, carbon monoxide (CO) and water reaction to form carbon dioxide and hydrogen. Yields based on CO exceed 90%.

A large portion of the unreacted CO is lost in the vent gas intended to remove hydrogen and carbon dioxide formed in the water gas shift reaction form the system. Publications suggest recovery of the CO by contacting the vent gas stream with hollow fiber membranes selectively permeable to hydrogen to form a non-permeated gas stream of higher CO content than the vent gas stream.

Design Bases

Reactor Conditions:
Total Pressure>450 psig
CO partial pressure, psig 200
Temperature: >350° F.
Catalyst composition 350 ppm Rh (based on reactor contents)
Methanol conversion: ˜100%
CO conversion: 92%
Selectivity of methanol to acetic acid, 99%
Allowance for plant losses 1% of product
Overall plant yield based on methanol: 98%
Overall plant yield based on CO: 91%

Catalyst Preparation and Regeneration

The catalyst mixture was prepared directly in the carbonylation reactor (the in situ procedure) or in separate catalyst reactors. Commercial plants prefer the latter procedure to ensure proper dissolving and complexing. The batch catalyst reactor serves both as a catalyst dissolver and as a catalyst residue concentrator. The rhodium component fed to the catalyst dissolver consists of a mixture of fresh makeup RhI₃ and spent catalyst. Catalyst preparation involves heating the spent catalyst solution (plus methanol) to 300° F. The pressure in the reactor is reduced, and the vapors are vented downstream. The reactor is cooled to room temperature agitation to precipitate out the rhodium component. The clear liquid on top of the precipitate is siphoned off and passed to the surge drum. A makeup RhI₃ catalyst is added to the reclaimed catalyst precipitate. Acetic acid is added to the reactor to dissolve the rhodium component at 275° F. under 80 psig CO pressure. The catalyst solution is cooled to room temperature and discharged to the storage drum. The clear liquid in another surge drum may still contain some dissolved metallic and halogen compounds. Before disposal, the solution is boiled in the reactor in the presence of methanol. The dissolved iodides and other light gases are vented through a scrubber. The unvaporized residues are sent to disposal.

This is a two-step reaction. The methyl iodide promoter is prepared in a second reactor. In the first step, iodide reacts with the water in the presence of a rhodium catalyst to form hydrogen iodide. This reaction takes place at 140° C. and less than 80 psig pressure. The gases leaving the reactor during this step are cooled to condense water and hydrogen iodide before they are sent to the flare. As iodide is consumed, the water-gas shift reaction occurs resulting in the evolution of hydrogen. When hydrogen is detected in the off-gas, the reactor is depressurized and the temperature lowered. Methanol is then added to the reactor. The hydrogen iodide reacts with the methanol to form methyl iodide. Methyl iodide is flashed off, condensed, and stored. It is then pumped to the carbonylation section of the plant.

Carbonylation

The carbonylation reaction between methanol (technical grade) and CO (98% purity) is carried out at >350° F. and >450 psig in a reactor. The heat of reaction is removed by circulation of the reaction product through an exchanger. A heater is provided for plant startup. The overall reaction occurring in the reactor is as follows:
CH3OH(l)+CO(g)→CH3COOH(l)

Estimated ΔH₂₉₈₌₋₃₃ kcal/gmol methanol (exothermic), wherein ΔH₂₉₈ is the enthalpy change at 298 degrees Kelvin. Small amounts of carbon dioxide and hydrogen are produced by a water gas shift reaction. Minor amounts of formic acid and propionic acid are also formed. Unreacted gases (mostly CO, nitrogen, and carbon dioxide) are vented through a gas cooler and vent gas scrubber. The liquid crude product stream from the reactor is flashed to 65 psig and 166° C. (330° F.) in a flash drum. The flashed vapors, containing acetic acid, water, methyl iodide, formic acid, and propionic acid, are sent to the purification section of the plant. The unvaporized liquid, which contains the rhodium catalyst, is returned to the carbonylation reactor. A small portion of the recycled catalyst stream (about 2%) is returned to the catalyst preparation section for regeneration. A recycled acetic acid stream from downstream product purification is stripped by reboiling before being returned to the carbonylation reactor via a surge drum.

Purification

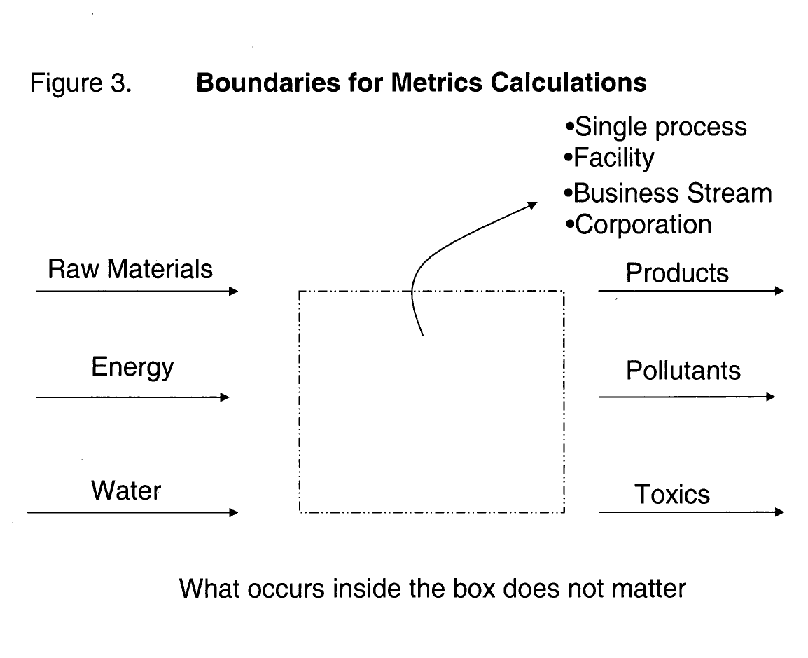

The crude product vapor stream from flash drum is distilled in a series of columns. Methyl iodide, methyl acetate, part of the water, part of the acetic acid, and a trace of unreacted methanol are separated from the crude acetic acid product stream in a crude fractionating column. The crude acetic acid is dehydrated and excess water in the system is purged. The dehydrated crude acetic acid is redistilled in refining column. Refined acetic acid leaves the column as a side stream at two plates below the top plate flows to storage. The net overhead of the column, containing mainly acetic acid and small amounts of residual water, formic acid, and methyl iodide, is recycled to the carbonylation reactor via a stripper. The bottoms from the refining column, containing acetic acid and propionic acid, are stripped to reduce the acetic acid content. Bottoms from the stripper leave the column as a crude propionic acid byproduct, which could be recovered or could be a waste. The overhead is recycled to the refining column (FIG. 3).

Raw Material Use

| | |
|---|---|
| Carbon Monoxide | 7.0628 scf |
| Rhodium | 0.068 mg |
| Methanol | 0.082 gal |

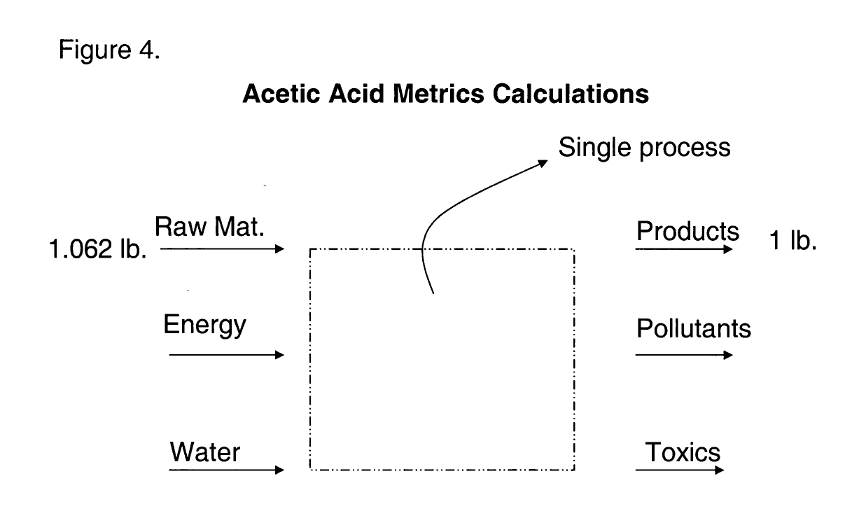

This translates into 1.062 lb of raw material per pound of product (FIG. 4).

Material Metric

The metric for materials intensity is expressed as the mass of raw materials less the mass of the product, per unit of output. The numerator is measured in or converted to pounds and the denominator is measured in physical terms (pounds of product) or financial terms (dollar revenue or value-added).

The material metric is expressed as the mass of raw material waste, rather than the mass of total materials consumed, as the metric was originally defined, in order to obtain a materials metric that is stackable along supply chains. Using total materials consumed would result in ‘double-counting’ the mass of products that become raw materials in a down-stream process.

The material metric is calculated on a dry basis. However, water and air are included in the metric when hydrogen or oxygen molecules form water or air are raw materials and become a part of the molecular make-up of the product. When this occurs, the stoichiometric requirement of oxygen or water is used in the metric calculation. Initially, all water and air was excluded from the metric calculation, which resulted in negative metrics for those products for which water or oxygen from air was a raw material in the reaction to form the product. Negative material metrics were not meaningful and led to perverse results when the metrics were compared. The inclusion of water and air as raw materials assures a positive metric, and also addresses some of the concerns raised by the workshop participants and project teams who felt that the material metric was incomplete, particularly in its omission of all water. Therefore, the material metric for this case is:
(1.062−1)/1.0=0.062

Energy Metric

For energy intensity, the basic metric is energy consumed from all sources (numerator, measured in or converted to Btus) per unit of manufactured output or service delivery (denominator, measured in physical or financial terms). For calculation of the product metrics, purchased electricity is assumed and the energy conversion for electricity usage includes a factor to account for the average losses incurred in the generation and transmission of electricity in the United States (0.31). Therefore, the energy metric for this case is 2.51 kbtu (one thousand British thermal units) per pound.

Water Use Metric

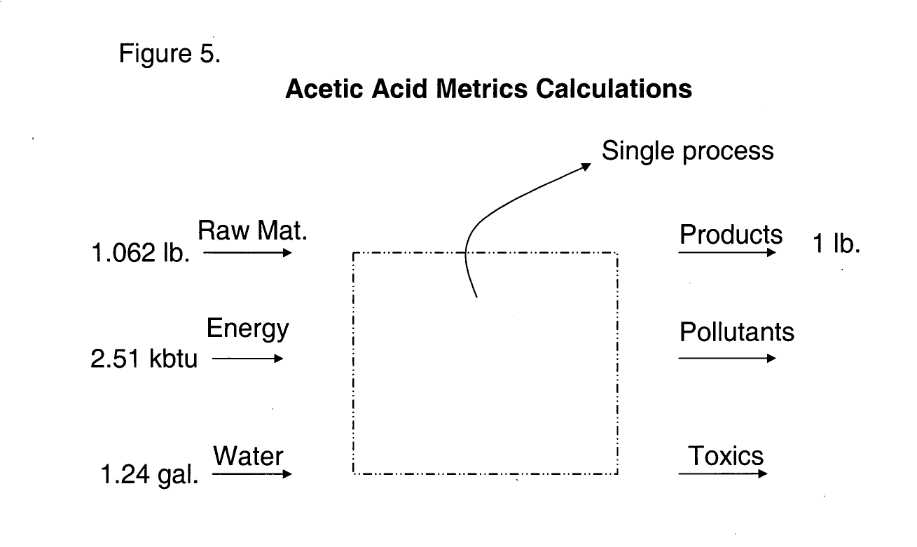

The water metric developed for the product metrics is “water rendered unavailable for beneficial use, expressed as gallons per unit of output.” The metric includes: water present in waste streams that must be treated because of chemical contamination, contact cooling water, water vapor that is vented to the atmosphere, water lost to deep-well injection and seven percent of non-contact cooling water. Severn percent is the factor used to account for water lost from a cooling tower due to evaporation and misting from wind. Therefore, the water metric for this case is 1.24 gallons per pound of product (FIG. 5).

Vent Gas Scrubbing

In this case, the reactor vent gases and vent gases from the purification columns are scrubbed in a single low-pressure column. Vents form the purification columns are scrubbed with chilled acetic acid in a lower pressure column. Also, the off-gas from the reactor scrubber is passed through a refrigerated condenser to reduce the amount of methanol lost to the flare.

Waste Streams

A summary of the waste streams generated within the plant are listed below.

Overhead stream from removal of excess water from the system: Impure propionic acid, 1107 lb./hr.

Scrubbed gases, unreacted carbon monoxide, inert gases, and methanol 5541 lb./hr.

Scrubbed gases are sent to a flare. It is assumed that the general waste treatment facilities handle the excess water, even though it contains some methyl iodide and acetic acid. The impure propionic acid is used as fuel in this case. Alternatively, the crude propionic acid could be further purified and sold, but the small amounts produced will likely make this economically unattractive.

### EXAMPLE 2

### Automated Metrics

An automated metrics tool is a sustainability metrics management application which can be built, for example, using the Windows Forms classes of the Microsoft .NET Framework or similar system. Automating metrics allows users to view, modify, and add project-based metrics data that is stored within a centralized database or can use information on a public database; for example, the USDOE Industrial Assessment Database or the Carnegie Mellon EIO database. The application can generate reports and charts in different formats that effectively help users to understand sustainability performance of a given project. It can be used in any number of scenarios, from real time performance tracking to conceptual process design or limited lifecycle analysis.

The automated metrics tool can incorporate many technologies provided by the .NET Framework including authorization to control user access to application features, data encryption, accessibility support, forming authentication using a database for user names/passwords, asynchronous XML Web service calls, ADO.NET data access using SQL stored procedures, and third party components for .NET Framework. The automated metrics tool can be written using the Visual Basic NET programming languages.

Here, the “localhost” is the server. Both the client and server applications can run on the same machine. If the server is running on the separate machine from the client, that machine's URL identifies the server. See Appendix A for an example code or programming.

Software Architecture

There are three components in a useful automated metrics tool architecture: database, Web services, and client application. The database server stores and manages a large volume of data that can be accessed by authorized users through XML Web services. All the objects within the database server are invisible to the end user while XML Web services can only get access to the queries. The XML Web services are responsible for the communications between the client and remote server. If the Web services are installed on a public server, they are accessible to any application over the internet that can supply a valid username and password. The use of XML Web services provides the great potential to interface with other applications with different formats; for example an ASP model. Alternatively, the XML Web services can also be run on the intranet, thus confining all data flow within an internal network.

The client applications are only interfaces created with Windows Forms classes. All data operations are handled at server side to increase the efficiency. This is a typical “thin” client architecture which will effectively reduce the maintenance or update work at multiple client locations.

The database, for example a Microsoft SQL Server 2000 can be used to store the shared data. A large number of views and stored procedures can be created to facilitate data query and processing. There are two types of data: project data and system data. Project data (e.g. the amount of product produced) is related to a certain project while system data (e.g. heating value of electricity) can be used by different projects and keeps constant most of the time.

Automating the metrics can use stored procedures to encapsulate all database queries. Stored procedures provide a clean separation between the database and the middle-tier data access layer. Appendix B is a stored procedure that creates a new project. XML Services perform data query and update between the client application and database server. Web services are grouped into two separate categories according to their functions: Authentication, which performs authorization process, wherein confidential information are encrypted during the process; and data, which performs data exchange. After user's identity is verified, project data can be encrypted. If the application is running under the public network and security is rather a priority over performance, a SSL can be applied to protect sensitive information.

An authentication service can be very simple. The service can validate the user name and password against the database (using a stored procedure), and then return a unique encrypted ticket with the user ID embedded. If the user name and password fail, then nothing is returned. The value of the ticket is cached for a specified period, e.g., two minutes, on the server after it is issued. This allows maintaining a server-side list of recently issued tickets. Because tickets are only maintained for a short time, clients are forced to re-authenticate often, which prevents situations in which an attacker impersonates the validated user. A System.Web.Security.Forms Authentication Ticket is chosen to embed data, such as a the user ID, within the ticket itself.

The Data Web Service

The Data Web service can enable the client to query/change project data on the remote database server and verify the status (success/failure). The server can “decide” whether the current user is valid by checking the existence of cached authentication ticket. The Authentication Web service can be called to verify the user. The service can also restrict unwanted activities. Appendix C is an example code for a “project” web method.

Windows Form Client Application

A client application interface, based on Windows Form Class, is visible in the Automated metrics tool software. In addition to the new smart client technologies provided by .NET Framework, Automated metrics tool also integrated some customized user controls as well as third party components.

User Interface Forms

With regard to the main interface, an explorer-style format makes it very easy for a user to visually navigate data. Data operation calls can return a result of either success or failure. If the result is successful, the displayed data in list-view will refresh automatically to reflect the changes. In order to fully represent the hierarchical structure of complex processes, a ‘tree-view’ can be used. Since a tree-view structure cannot be directly linked to relational data source at design time, a user function is created to enable the software to read relational data and draw the tree-view at runtime. Appendix D is an example of the code which can be used to create the tree nodes.

There are three third party .NET components (Crystal Reports, dundas Charts, and ComponentOne Flexgrid) that may be used to display the metrics results.

### EXAMPLE 3

### Total Cost Assessment

The presence of an odor in a residential area may lead to reduced enjoyment of the homeowners property because of inability to use the exterior land of the facility and/or to have open ventilation in the home. Likewise, eutrophication may reduce the aesthetic beauty of waterfront or waterview property. “Eutrophication” is the unintentional enrichment of either fresh or salt water by chemical elements or compounds. The nutrients supplied promote algae growth. Eutrophication may also cause odors. Certainly, eutrophication can result in loss of enjoyment of swimming, fishing and water sports.

The presence of odors from a manufacturing location may cause uncertainties with regard to the nature of the compounds causing the odors. This concern, if severe enough, may have psychological impacts. Another impact area is physical health. Stress-related disorders CAN include sleep loss, gastro-intestinal symptoms, hypertension. These disorders may require doctor visits, pharmaceutical and over-the-counter remedies.

Once affected by one or more of the stresses, individuals can choose to take voluntary actions. There are costs associated with the actions they choose. They are also further impacted by changes beyond their control, which carry involuntary, system-imposed costs. They may join local citizen groups, or recognized national groups. They may organize and form their own group for a specific situation. In either case, they will incur the direct or indirect cost of dues, of meeting attendance and of correspondence. They may hire legal counsel. They may contact regulators or elected officials, which indirectly increases the cost to them through potentially higher taxes. Costs accrue to the government (and indirectly to the taxpayer) to investigate the complaint: answering the call, time for the investigator, use of government vehicles, computers, telephones, etc. If the situation is serious enough, the resident may choose to relocate and incur all the costs associated with such an action.

At the same time, there may be system-imposed costs to the residents. The property value may decline or fail to appreciate as much it might without the effects of odor or eutrophication of nearby waterways. Tourism may decline as was the case in Erie, Pa. in the decades of 1960 and 1970 and, is the case today in areas where major animal feeding facilities have located. Development may be hindered because of the unwillingness of lenders to finance development or by the loss of government incentives. Employment may also decline due to loss of jobs related to tourism, fishing, homebuilding, etc.

Eventually, these external, intangible costs borne by society manifest themselves in internal company costs: Type I costs such as capital and operating costs for equipment; Type II costs such as salaries for corporate legal staff, punitive damages paid at the corporate level and increased costs for public relations staff; Type IV costs such as lost good will, employee productivity or increased costs to retain employees who are weary of being ostracized in the community.

There are many ways for companies to abate odors. Equipment can be installed and operated. Absorbers, adsorbers, biofilters, chiller/condensers, filters, incinerators, regenerative and non-regenerative thermal oxidizers and scrubbers are a few examples.

The potential impact of Global Warming (Greenhouse Gas Emissions) is the newest area of external intangibles that concerns manufacturing companies and insurers. The issue areas where effects may ultimately be monetized are:
Agricultural
Human Health
Food Production
Drought
Flood
Population Displacement
Diminished Food Security
Fresh Water Availability
Infectious Diseases
Desertification
Infrastructure Stress
Loss of biodiversity
Heat Stress
Coral population
Mangrove population
Coastal areas
Tundra health
Wetlands health
Forested area
Glacial retreat
Threats to Fisheries
Soil Salinization
Coastal Erosion
Tropical Cyclones
Thermal Water Pollution
Sea Level Rise

Values for the net present values of each of these items are being developed now and will be used in the future as a data set for automated calculation of total costs.

Those skilled in the art will recognize, or be able to ascertain using no more than routine experimentation, many equivalents to the specific embodiments of the invention described herein. Such equivalents are intended to be encompassed by the following claim.

Appendix A:

<appSettings>
<!-- User application and configured property settings go here.-->
<!-- Example: <add key=“settingName” value=“settingValue”/> -->
<add key=“MetricsWorks.AuthWS.AuthService”
value=“http://localhost/MetricsWorks/authservice.asmx”/>
<add key=“MetricsWorks.DataWS.DataService”
value=“http://localhost/MetricsWorks/dataservice.asmx”/>
</appSettings>
</configuration>

Appendix B:

CREATE PROCEDURE InsertProject
(
@ProjectTypeID int,
@ProjectName varchar(50),
@ParentProjectID int,
@PeriodTypeID int,
@CurrencyID int,
@IsRawMaterialRecycle bit,
@IsRawMaterialToxic bit,
@IsWaterByUse bit,
@IsEndangerEcosys bit,
@UserID int
AS
SET NOCOUNT OFF;
INSERT INTO Projects
(ProjectTypeID,ProjectName,ParentProjectID,PeriodTypeID,
CurrencyID,IsRawMaterialRecycle,IsRawMaterialToxic,
IsWaterByUse,IsEndangerEcosys,CreatedBy,LastModifiedBy,
CreatedAt,LastModifiedAt) VALUES
(@ProjectTypeID, @ProjectName,
@ParentProjectID,@PeriodTypeID,@CurrencyID,
@IsRawMaterialRecycle,
@IsRawMaterialToxic,@IsWaterByUse,@IsEndangerEcosys,@UserID,
@UserID,getdate( ), getdate( ));
SELECT @@IDENTITY AS ProjectID
GO

Appendix C:

```
<WebMethod( )> _{—}
    Public Function InsertProject(ByVal ticket As String, ByVal
ProjectName As String, ByVal typeID As Integer, ByVal periodID As
Integer, ByVal ParentID As Integer, ByVal UserID As Integer, ByVal
ParentProjectInfo As ProjectInfo) As Integer
        If Not IsTicketValid(ticket, True) Then Return −1
        Try
            Dim ProjectID As Object
            ProjectID = SqlHelper.ExecuteScalar(dbConn,
“InsertProject”, typeID, ProjectName, ParentID, periodID,
            ParentProjectInfo.CurrencyID, _{—}
ParentProjectInfo.IsRawMaterialRecycle,
            ParentProjectInfo.IsRawMaterialToxic, ParentProjectInfo.IsWaterByUse, _{—}
            ParentProjectInfo.IsEndangerEcosys, UserID)
            If ProjectID Is Nothing Then
                Return −1
            Else
                Return CInt(ProjectID)
            End If
        Catch ex As SqlException
            If ex.Number = 2627 Then
                ‘ SQL Server has detected a unique key constraint
violation on
                ‘ the Project Name column. Return the flag value for
this case.
                Return 0
            Else
                Throw ex
            End If
        Finally
            dbConn.Close( )
        End Try
    End Function
```

Appendix D:

```
Private Sub CreateNodesOfParent(ByVal iParent As Integer, ByVal pNode
As TreeNode)
        Dim dvData As New DataView(m_DataLayer.
        DsProjects.Projects)
        dvData.RowFilter = “ParentProjectID=” & iParent
        Dim Row As DataRowView
        For Each Row In dvData
            If pNode Is Nothing Then
                Dim zNode As TreeNode =
tvProject.Nodes.Add(Row(“ProjectName”))
                Dim m_ProjectTag( ) As Integer = {−1, −1, −1, −1}
                m_ProjectTag(0) = Row(“ProjectID”)
                m_ProjectTag(1) = Row(“ProjectTypeID”)
                zNode.Tag = m_ProjectTag
                zNode.ImageIndex = 0
                znode.SelectedImageIndex = 0
                CreateNodesOfParent(Row(“ProjectID”), zNode)
            Else
                Dim zNode As TreeNode=
pNode.Nodes.Add(Row(“ProjectName”))
                Dim m_ProjectTag( ) As Integer = {−1, −1, −1, −1}
                m_ProjectTag(0) = Row(“ProjectID”)
                m_ProjectTag(1) = Row(“ProjectTypeID”)
                znode.Tag = m_ProjectTag
                Select Case Row(“ProjectTypeID”)
                    Case 1
                        znode.ImageIndex = 1
                        znode.SelectedImageIndex = 1
                    Case 2
                        znode.ImageIndex = 2
                        znode.SelectedImageIndex = 2
                    Case 3
                        znode.ImageIndex = 3
                        znode.SelectedImageIndex = 3
                        m_ProjectTag(2) = Row(“PeriodTypeID”)
                        ‘If Performance tracking project,add period
nodes
                        Dim dvPeriod As New
DataView(m_DataLayer.DsProjects.ProjectByPeriod)
                        dvPeriod.RowFilter = “ProjectID=” &
Row(“ProjectID”)
                        Dim RowPeriod As DataRowView
                        Dim cNode As TreeNode
                        For Each RowPeriod In dvPeriod
                            If Row(“PeriodTypeID”) = 1 Then
                                ‘period by Year
                                cNode =
Znode.Nodes.Add(RowPeriod(“PeriodByYear”))
                                Dim m_ProjectPeriodTag( )
                                As Integer =
{−1, −1, −1,−1}
                                m_ProjectPeriodTag(0) =
Row(“ProjectID”)
                                m_ProjectPeriodTag(1) =
Row(“ProjectTypeID”)
                                m_ProjectPeriodTag(2) =
Row(“PeriodTypeID”)
                                m_ProjectPeriodTag(3) =
RowPeriod(“ProjectByPeriodID”)
                                cNode.Tag = m_ProjectPeriodTag
                            Else
                                ‘Period by MonthOrQuarter
                                Dim intMonthOrQtrID As Integer
                                intMonthOrQtrID =
RowPeriod(“MonthOrQuarterID”)
                                Dim rowMonthOrQtr
                                As DataRow =
m_DataLayer.DsProjects.MonthOrQtr.Rows.Find(intMonthOrQtrID)
                                cNode =
znode.Nodes.Add(rowMonthOrQtr(“MonthOrQtrName”) & “,” &
RowPeriod(“PeriodByYear”))
                                Dim m_ProjectPeriodTag( )
                                As Integer =
{−1, −1, −1,−1}
                                m_ProjectPeriodTag(0) =
Row(“ProjectID”)
                                m_ProjectPeriodTag(1) =
Row(“ProjectTypeID”)
                                m_ProjectPeriodTag(2) =
Row(“PeriodTypeID”)
                                m_ProjectPeriodTag(3) =
RowPeriod(“ProjectByPeriodID”)
                                cNode.Tag = m_ProjectPeriodTag
                            End If
                            cNode.ImageIndex = 4
                            cNode.SelectedImageIndex = 4
                        Next
                End Select
                CreateNodesOfParent(Row(“ProjectID”), zNode)
            End If
        Next
    End Sub
```

1. A method of determining the raw material and land use inputs for a product to be manufactured or a service to be rendered, and determining the non-product outputs of producing the product or delivering the service, comprising the steps:
a. obtaining an inventory of materials and land necessary for production of the product or delivery of that service; and
b. quantifying the non-product outputs of the production or delivery, wherein the raw material inputs and non-product outputs are numerical values that are converted into common units.

2. A method of determining an estimate of the benefits and costs for a product to be manufactured or a service to be rendered, and determining an estimate of the non-product outputs of producing the product or delivering the service, comprising the steps:
a. obtaining an inventory of materials and land necessary for production of the product or delivery of that service; and
b. estimating the non-product outputs of the production or delivery, wherein the raw material inputs and non-product outputs are estimated numerical values that are converted into common units.

3. The method of claim 1, wherein the common unit numerical values are compared in terms of their negative impacts or their benefits.

4. The method of claim 1, wherein actual production numbers are compared with standard known cases of production or delivery.

5. The method of claim 1, further comprising,
c. incorporating surrogate numbers for missing information.

6. A method of assessing the potential total cost and benefit impact of a pending governmental agency decision.

7. A method for identifying, assessing, and optimizing future impacts of research and development decisions on a technology comprising the steps:
a. obtaining an inventory of materials and land necessary for production of the product or delivery of that service; and
b. quantifying the non-product outputs of the production or delivery, wherein the raw material inputs and non-product outputs are numerical values that are converted into common units.

8. The method of claim 7, wherein the decisions are made during development of the technology.

9. The method of claim 7, wherein the decisions are made during commercialization of the technology

10. A method for comparing estimated non-traditional costs with a service to be provided, comprising
a. monetizing the non-traditional costs, and
b. comparing the monetized value with the service to be provided.

11. A graphic user interface software which allows for visual representation of computed metrics and costs.

12. A method for utilizing government databases to calculate benchmark metrics for uses selected from the group consisting of material use, energy use, water use, land use, toxic materials emitted and overall pollutants emitted, for a product manufactured or a service rendered, comprising the steps of:
a. extracting data from the databases.
b. calculating benchmark metrics from the data.

13. The method of claim 12 wherein the land use metrics are further defined by incorporating positive and negative impacts of selecting one type of manufacturing over another for use of the land.

14. A method for quickly and reproducibly representing the sustainability of a process, a facility, a project alternative, a business or a company which is understandable to the non-expert, comprising
a) selecting metrics to be measured;
b) calculating the selected metrics.

15. The method of claim 14, further comprising
c) assessing and reporting the calculated metrics relative to external benchmarks, wherein goals can be set and progress can measured.
